(19) United States
(12) Patent Application Publication
(10) Pub. No.: US 2006/0155331 A1
(43) Pub. Date: Jul. 13, 2006

(54) Pacifier for administering flavour substances

(76) Inventor: Bernard Roald Bohmer, Osio (NO)

Correspondence Address: SIERRA PATENT GROUP, LTD., 1657 Hwy 395, Suite 202, Minden, NV, 89423, US

(21) Appl. No.: 10/539,950

(22) PCT Filed: Feb. 12, 2003
(86) PCT No.: PCT/NO03/00053

§ 371 Date: Jun. 17, 2005

(30) Foreign Application Priority Data
Dec. 17, 2002 (NO) 2002-6068

(51) Int. Cl. A61J 17/00

(52) U.S. Cl. 606/234

(57) ABSTRACT

Pacifier for receiving a cartridge (2) containing flavour substances for oral intake. The pacifier comprises a base part (3) with a cartridge chamber (3d), a nipple (4), at least one flow channel (5) between the cartridge chamber and at least one hole (8) that is communicating with the flow channel (5) in the nipple. The flow channel (5) is formed in the nipple (4).

The present invention relates to a pacifier with means for the insertion a cartridge containing flavoured substances that are to be ingested orally, in accordance with the preamble of claim 1 below.

All parents of young children will at times experience the frustration of not being able to soothe a crying or distressed child. This applies especially to children under two years of age. Some children use a pacifier and in many cases calm down as soon as it is put in their mouth. However, this does not always work. This generally happens in the most awkward situations, such as in a shopping mall in the middle of the Christmas rush, during a theatrical performance, in church during a wedding or the like. These are situations where the parents are already under some stress. The parents then become even more stressed. Children of this age are highly sensitive to stressed parents and they then become even more distressed. This becomes a viscous circle that is no good for either the child or the parents.

Some parents try to calm the child with a feeding bottle, which in some case may help. However, the child is often not hungry or thirsty, and there is also a risk of overfeeding if a feeding bottle is used too often. Juice, milk or the like can also be harmful if the infant has started to cut teeth. Water is an alternative, but will only work if the infant really is thirsty. As infants should only drink warm liquids, another problem may be to get the drink warmed up.

Food, especially in the form of sweets or biscuits, is another solution. However, this will only work for older children and not for infants who have not yet become accustomed to solids. Harm to the teeth may also be a problem here. Whether the child is hungry or not may also be a critical factor.

A drawback that is common to the two aforementioned methods is spilt liquid or food debris on clothes and the like.

U.S. Pat. No. 5,123,915 describes a pacifier adapted to receive a capsule containing medicine. When the capsule is inserted into a chamber in the rear end of the pacifier, the capsule will be punctured and the medicine will drip into the cavity of the actual nipple. From here the infant can suck the medicine out through a hole in the end of the nipple.

It is quite possible that this pacifier is highly suitable for administering medicines. The medicine will be administered to the infant relatively quickly. However, it is not suitable for the purpose of the present invention, namely to comfort the infant by giving him flavoured substances over a sufficiently long period of time. If flavoured substances were fed to the infant via the pacifier in U.S. Pat. No. 5,123,915, the substance would be consumed within a very short time. After this, the infant would not have had the same comfort from the pacifier and might also be disappointed over the lack of taste and spit the pacifier out.

Moreover, saliva could easily penetrate into the cavity of the nipple through the hole in the tip of the nipple. The saliva could accumulate in relatively large amounts in this comparatively large cavity. Saliva always contains bacteria, both harmless and harmful, and if saliva remains in this cavity, the bacteria will be able to multiply and become a source of both an unpleasant smell and illness.

Other known pacifiers made for administering medicines and/or flavoured substances are described in U.S. Pat. No. 404,950, U.S. Pat. No. 745,920, U.S. Pat. No. 3,875,940 and U.S. Pat. No. 4,192,307. All these pacifiers have drawbacks, the first three because the administration takes place over too short a time and the last-mentioned because it is only capable of administering solid substances.

There is thus a need for a pacifier that is adapted for administering liquid or paste-like flavoured substances, where the administration thereof takes place over a considerable period of time. The period of time should be at least 10 minutes and preferably even longer than this.

Administration over a long period of time will also have a positive effect on dental care, as the influx will be so small that the flavoured substances barely reach the teeth, but are swallowed as they enter the mouth. To the extent that they reach the teeth, the flavoured substances will be quickly diluted by the saliva to a level that has little impact on the teeth. Optionally small amounts of substances that are good for the teeth such as sorbitol or fluorine could be added. The substance containing the flavours should preferably be sugar-free.

This is achieved by the features as disclosed in the characterising clause of claim 1.

The device for administering flavoured substances according to the invention has the general appearance of a pacifier. It comprises a chamber into which a cartridge containing flavoured substances is inserted. The cartridge is preferably a single-use cartridge. The actual pacifier can be cleaned and used many times. The cartridge will contain the substance comprising the flavours which the infant can ingest. As flavoured substances it is preferable to use a viscous substance.

Because of the narrow channel in the nipple, it will not be that easy for saliva to penetrate therein, and if any were to enter, there would not be room for large amounts of it. Therefore the possibility of harmful bacteria multiplying is small.

How quickly the substance is administered depends upon the design of the channel between the cartridge and the end of the nipple, how great an air supply there is inside the cartridge for replacing the substance that is sucked out, and how viscous the substance is. It may be advantageous to provide substances of different viscosity. When highly viscous substances are used, it will take a long time to empty the cartridge whilst light-fluid substances can be used when it is more important that the infant should take nourishment than that the cartridge should last a long time.

The flavoured substances will preferably be natural substances, for example, products made of fruits and berries. When the cartridge is inserted into the pacifier, the infant will be able to settle down for a long or short period, and if the substance also contains nutrients (vitamins, minerals etc.), he will also be given some healthy nourishment.

The pacifier according to the invention will be practical for parents of young children. The pacifier will capture the infant's interest if he cries and calm him down, thereby allowing the parents to have a little time, for example, to finish their shopping or watch the rest of the theatrical performance, or enabling them to avoid having to leave the church in the middle of a wedding.

Young children should have food at frequent intervals, and in some cases the parents are not capable of meeting the infant's needs as quickly as the infant would like, or they are unable to do so for practical reasons, for example, when they are driving a car. In that case, the present invention would be very practical because the infant will be given nourishment without any mess and will calm down until the parents are in a position to feed him.

Thus, the pacifier according to the invention will in many situations give parents some time because the infant becomes interested in the pacifier and the food, and because the infant becomes calm owing to the fact that he is actually given something to eat.

The pacifier according to the invention is very simple to carry around, and it is possible to provide substances of different tastes and compositions. Moreover, the pacifier can be made in different colours and different designs, in the same way as conventional pacifiers. There is no need to heat milk or have any other equipment at hand as is necessary with feeding bottles. The invention can be used as an ordinary pacifier, and a cartridge can be inserted as required.

The invention will now be described in more detail with reference to the attached drawings, wherein:

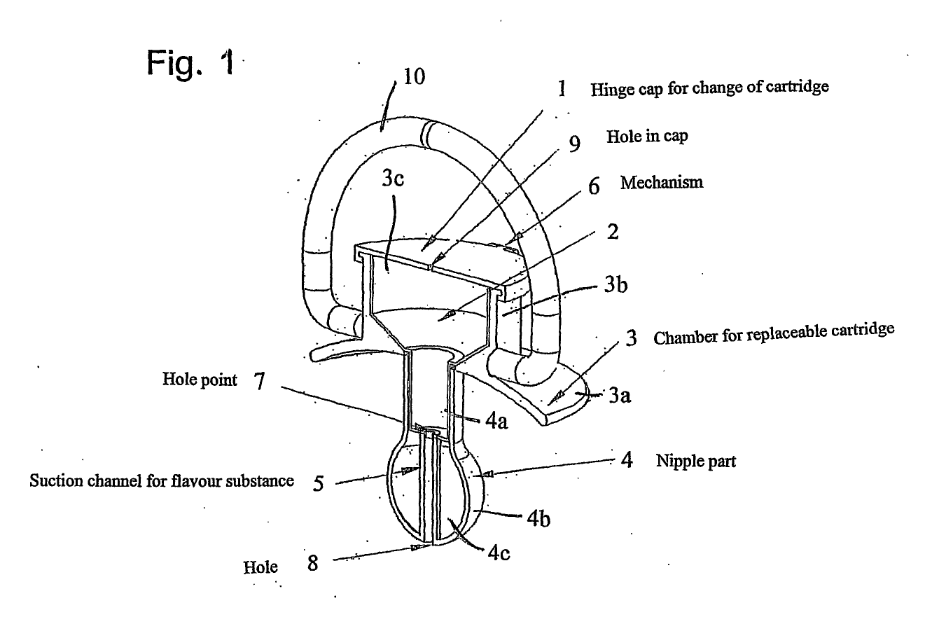

FIG. 1 shows in perspective and longitudinal section a pacifier according to the present invention in a first embodiment;

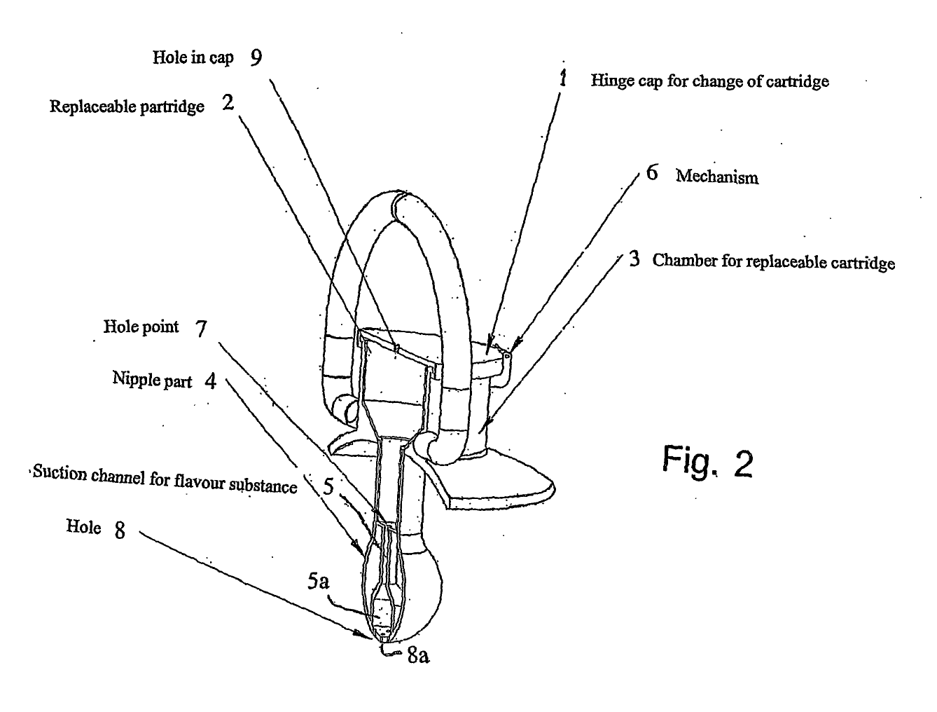

FIG. 2 shows in perspective and longitudinal section a pacifier according to the present invention in a second embodiment;

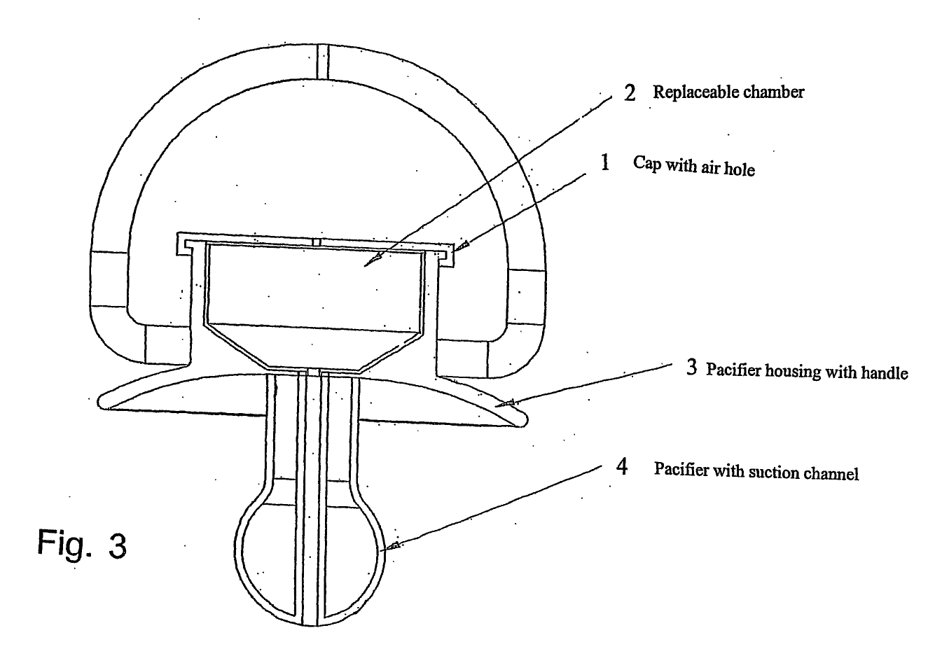

FIG. 3 shows a longitudinal section through a pacifier according to the present invention in a third embodiment;

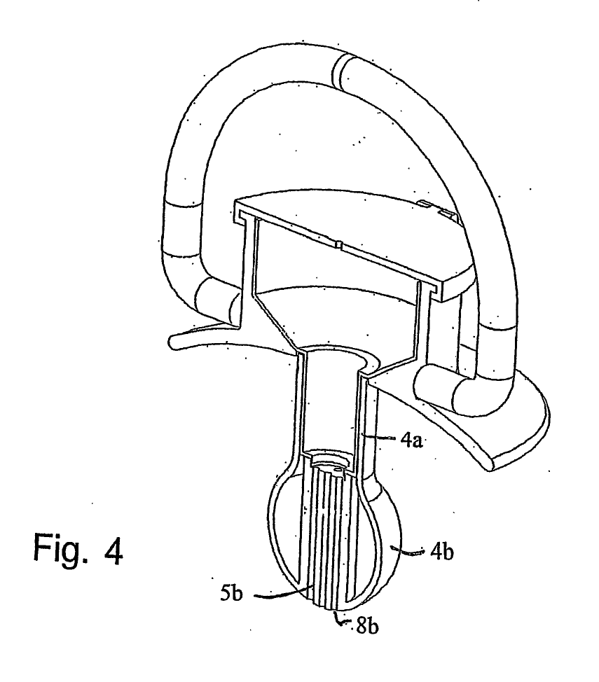

FIG. 4 shows in perspective and longitudinal section a pacifier according to the present invention in a fourth embodiment;

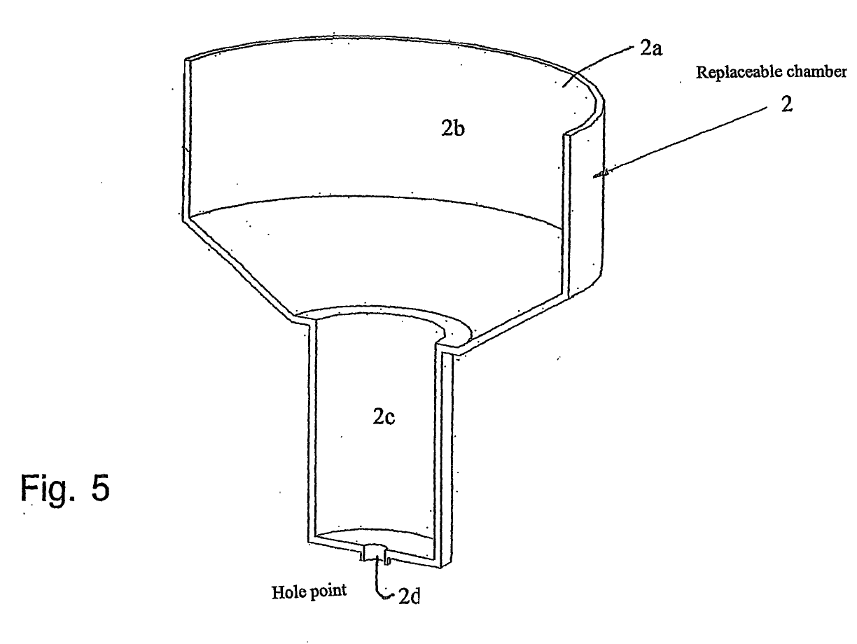

FIG. 5 shows in perspective and longitudinal section a cartridge according to the present invention in a first embodiment; and

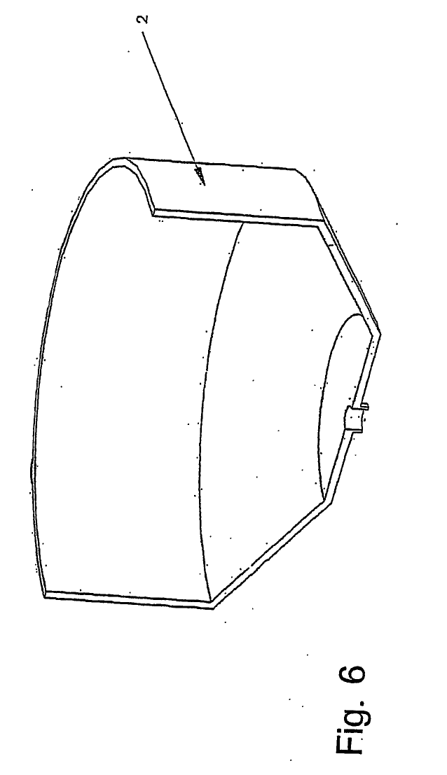

FIG. 6 shows in perspective and longitudinal section a cartridge according to the present invention in a second embodiment.

When reference is made in the following to upper and lower ends or upper and lower parts, it should be understood that this simply refers to the orientation of the figures in the drawings and not the position of use of the invention.

A first embodiment of the invention is shown in FIG. 1. This generally consists of a base part 3, comprising a disc 3a and a chamber part 3b, a nipple 4 and a ring/handle part 10. The ring/handle part 10 may also be omitted without having any effect on the function of the pacifier.

The chamber part 3b has an opening 3c which can be closed using a cap 1. The cap 1 is preferably hinged by a hinge 6, to prevent it from being lost when it is opened. The cap is also equipped with a hole 9 for the admission of air.

In the chamber 3d of the chamber part 3b, there is space for a cartridge 2. The cartridge is replaceable and is preferably a single-use cartridge. The cartridge 2 is best shown in FIG. 5. The cartridge 2 is preferably made of a rigid material, for example, a plastic material suitable for use with foods. It has an opening 2a at its upper end. This opening is preferably covered by a tear-off sheet (not shown) or a sheet that can be pierced by a piercing means (not shown) arranged on the inside of the cap 9. This piercing means may be a hollow piercing means which comprises the air hole 9. The opening 2a may also be smaller than shown, as there may be a hole of a certain size in an upper end wall. In a first embodiment of the cartridge 2, it has an upper chamber 2b of large diameter and a lower chamber 2c of small diameter. At the lower end, the cartridge has an outlet hole 2d. This may also be equipped with a tear-off sheet or a sheet (not shown) that can be pierced by a piercing means. The sheet may be of metal or plastic.

In a second embodiment, shown in FIG. 6, the cartridge 2 does not have a lower chamber.

Reference is again made to FIG. 1. The nipple 4 comprises an upper part or stem part 4a for receiving the lower chamber part 2c of the cartridge. It also has a lower spherical part 4b. A channel 5 is formed in the spherical part and ends in a hole 8 in the surface of the spherical part. The channel consists preferably of a tube surrounded by an air-filled space 4c. However, it is also possible to make the nipple 4 of a solid elastic material through which the channel 5 extends.

The nipple 4 is fastened to the base part 3 in a manner that is known per se from conventional pacifiers.

When the cartridge 2 is to be inserted into the pacifier, the lower chamber part 2c thereof is passed into the chamber part 3b of the base part 3. A hollow piercing means (not shown) which pierces a sheet covering the hole 2d is preferably provided at the lower end of the stem part 4a of the nipple 4. Thus, communication between the interior of the cartridge 2 and the channel 5 is provided. When the cap 1 is closed and locked, preferably by means of a snap fit over the edge of the chamber part 3b, the sheet over the upper opening 2a of the cartridge 2 is also preferably perforated, so that communication is provided between the interior of the cartridge and the surroundings through the air hole 9. This hole is so small that there is no leakage or very little leakage of the cartridge contents through the hole 9.

When the infant begins to suck on the pacifier, the contents of the cartridge 2 will be drawn out into the channel 5, through the hole 8 and into the infant's mouth. Air will flow through the hole 9 and into the cartridge to replace the volume of the substance that is sucked out of the cartridge 2. If an air leak past the cap 1 can be provided in another way, the hole 9 may be omitted.

The length and diameter of the channel 5, and thus the flow resistance in the channel 5, the air supply through the hole 9 and the viscosity of the substance in the cartridge 2 are adapted to each other so that the flow of substance through the channel 5 is controlled and restricted. Thus, it will take some time before the infant manages to suck the cartridge empty and a cartridge will last for a certain period of time. The diameter 5 of the channel is preferably less than 1 mm, but may be even smaller, for example, 1/10 mm or less, depending upon how viscous the substance is.

The embodiment in FIG. 2 differs from that in FIG. 1 in that the channel 5 in the lower part is enlarged into a prechamber 5a. From the prechamber 5a, several holes 8a are formed through the spherical part 4b. In this way, the prechamber 5a can be filled up when the infant is not sucking on the pacifier so that a dose is ready when the infant begins to suck again. This may be an advantage since as a rule infants do not suck constantly, but take breaks from time to time.

The embodiment in FIG. 3 differs from that in FIG. 1 in that the channel 5 extends along the entire length of the nipple 4. The cartridge in this case is of the type shown and described in connection with FIG. 6.

The embodiment in FIG. 4 differs from that in FIG. 1 in that there are several separate channels 5b between the stem part 4a and hole 8b in the spherical part 4b.

1-10. (canceled)

11. A pacifier for receiving a single use cartridge containing flavoured substances that are to be ingested orally, comprising:
a base part having a cartridge chamber;
a nipple;
at least one flow channel between the cartridge chamber and the nipple; and
at least one hole that is in communication with the flow channel in the nipple, the flow channel being at least formed in the nipple,
the pacifier characterised in that the flow channel has a minimum diameter of less than 1 mm, that the cartridge has a volume substantially larger than the volume of the flow channel, and that the base part is equipped with a cap at an insertion opening to the cartridge chamber for the cartridge.

12. The pacifier according to claim 11, characterised in that the flow channel extends along almost the entire length of the nipple.

13. The pacifier according to claim 11, characterised in that several parallel flow channels are formed in the nipple.

14. The pacifier according to claim 11, characterised in that a prechamber in the form of an enlargement of the flow channel is formed at the at least one hole.

15. The pacifier according to claim 11, characterised in that the cartridge chamber extends some way into the nipple.

16. The pacifier according to claim 11, characterised in that the cap is a hinged cap.

17. The pacifier according to claim 16, characterised in that the cap is equipped with an air inlet hole, preferably in connection with a hollow piercing means for piercing the cartridge.

18. The pacifier according to claim 11, wherein the cartridge is characterised in that it comprises a housing of a substantially rigid material and at the end thereof that is to be inserted into the pacifier is equipped with a pierceable sheet that is arranged to be pierced by suitable means in the pacifier in order to open communication between the interior of the cartridge and the flow channel.

19. The pacifier according to claim 18, wherein the cartridge is characterised in that it comprises a tear-off or pierceable sheet at an opening at the cartridge end opposite the insertion end.

20. The pacifier according to claim 18, wherein the cartridge is characterised in that the cartridge has a portion that is designed to extend some way into the nipple.

21. The pacifier according to claim 12, characterised in that several parallel flow channels are formed in the nipple.

22. The pacifier according to claim 12, characterised in that a prechamber in the form of an enlargement of the flow channel is formed at the at least one hole.

23. The pacifier according to claim 13, characterised in that a prechamber in the form of an enlargement of the flow channel is formed at the at least one hole.

24. The pacifier according to claim 13, characterised in that the cartridge chamber extends some way into the nipple.

25. The pacifier according to claim 14, characterised in that the cartridge chamber extends some way into the nipple.

26. The pacifier according to claim 12, characterised in that the cap is a hinged cap.

27. The pacifier according to claim 13, characterised in that the cap is a hinged cap.

28. The pacifier according to claim 14, characterised in that the cap is a hinged cap.

29. The pacifier according to claim 15, characterised in that the cap is a hinged cap.

30. The pacifier according to claim 12, wherein the cartridge is characterised in that it comprises a housing of a substantially rigid material and at the end thereof that is to be inserted into the pacifier is equipped with a pierceable sheet that is arranged to be pierced by suitable means in the pacifier in order to open communication between the interior of the cartridge and the flow channel.

31. The pacifier according to claim 13, wherein the cartridge is characterised in that it comprises a housing of a substantially rigid material and at the end thereof that is to be inserted into the pacifier is equipped with a pierceable sheet that is arranged to be pierced by suitable means in the pacifier in order to open communication between the interior of the cartridge and the flow channel.

32. The pacifier according to claim 14, wherein the cartridge is characterised in that it comprises a housing of a substantially rigid material and at the end thereof that is to be inserted into the pacifier is equipped with a pierceable sheet that is arranged to be pierced by suitable means in the pacifier in order to open communication between the interior of the cartridge and the flow channel.

33. The pacifier according to claim 19, wherein the cartridge is characterised in that the cartridge has a portion that is designed to extend some way into the nipple.
